(19) United States
(12) Patent Application Publication
(10) Pub. No.: US 2004/0021321 A1
(43) Pub. Date: Feb. 5, 2004

(54) Portable power generator

(76) Inventor: Robert C. Rajewski, Stettler (CA)

Correspondence Address: THOMPSON LAMBERT, SUITE 703D, CRYSTAL PARK TWO, 2121 CRYSTAL DRIVE, ARLINGTON, VA, 22202

(21) Appl. No.: 10/206,996

(22) Filed: Jul. 30, 2002

(51) Int. Cl. H02P 9/04

(52) U.S. Cl. 290/1 R

(57) ABSTRACT

Electrical power is generated at a well site by using the drive train of a vehicle to power an electrical generator. The electrical generator feeds a transmission line of a public utility.

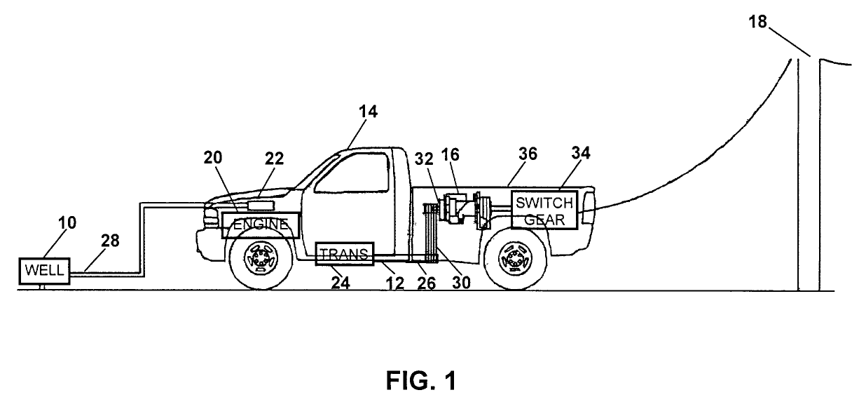

### BACKGROUND OF THE INVENTION

This invention relates to the production of electricity at remote locations, particularly at gas wells.

Gas wells may be high, mid or low producers. For low producing wells, economic delivery of gas to consumers poses a substantial challenge. In some cases, the economics might not warrant providing the gas to a gas pipeline, nor may it be permissible to flare the gas. There is therefore a need to use the gas in an efficient manner, without waste. This invention is directed towards providing a simple, cost effective solution to the problem of economic delivery of energy from gas produced at low producing wells, and also has applicability to other wells.

### SUMMARY OF THE INVENTION

This invention therefore provides a power generation system, comprising a vehicle having a natural gas powered engine and drive train; a fuel gas line for feeding the natural gas powered engine from a gas well; an electric power generator driven by the drive train of the vehicle, the electric power generator having an electrical output; and a transmission line interface for receiving electrical output from the electric power generator and delivering electrical energy to a transmission line. In a typical use, the vehicle is parked at a well site and the fuel gas line is connected to the gas well. The transmission line is typically owned by a public utility.

These and other aspects of the invention are described in the detailed description of the invention and claimed in the claims that follow.

### BRIEF DESCRIPTION OF THE DRAWINGS

There will now be described preferred embodiments of the invention, with reference to the sole FIGURE, by way of illustration only and not with the intention of limiting the scope of the invention, the FIGURE showing a side view schematic of an embodiment of the invention.

### DETAILED DESCRIPTION OF PREFERRED EMBODIMENTS

In this patent document, the word “comprising” is used in its non-limiting sense to mean that items following the word in the sentence are included and that items not specifically mentioned are not necessarily excluded. The use of the indefinite article “a” in the claims before an element means that one of the elements is included, but does not specifically exclude others of the elements being present, unless the context clearly requires that there be one and only one of the elements.

Referring to the sole figure, there is shown a power generation system, in which electrical power is generated at the site of a gas well 10 by using the drive train 12 of a vehicle 14 to power an electrical generator 16. The electrical generator 16 feeds a transmission line 18 of a public utility. The vehicle 14 may be a commercially available ¾ ton truck with an internal combustion engine 20 with a natural gas intake manifold 22, the engine generating preferably 180 to 300 hp. The vehicle 10 preferably has a conventional tachometer (not shown) and cruise control (not shown). The gas intake manifold 22 may be of conventional design as supplied by the vehicle manufacturer or may be a carburetor available from Impco™ of Cerritos, Calif., USA and Sterling Heights, Mich., USA. General Motors™ trucks such as the 2500 series, two wheel drive, or Dodge™ trucks may be used with good success, but any other make with sufficient power and reliability would be suitable. The drive train 12 of the vehicle 14 includes a conventional transmission 24 and drive shaft 26.

A fuel gas line 28 is connected between the gas well 10 and the gas intake manifold 22 for feeding the engine 20 with gas produced directly from the gas well 10. The electric power generator 16 is driven by the drive train 12 of the vehicle 14 through a belt drive 30 coupled between the drive shaft 26 and the shaft 32 of the electric generator 16. Any of various ways may be used to connect the shafts 26 and 32. Electrical output from the electric generator 16 is delivered through transmission line interface 34 to the transmission line 18. The electric generator 16 is a commercially available generator. The transmission line interface 34 contains commercially available electrical components such as switch gear, transformers and protection devices for receiving the electrical energy from the generator 16 and delivering it to the transmission line 18. Transformers are used in the transmission line interface to step up the voltage from the electric generator 16 as required for the transmission line 18. Switch gear is used to connect or disconnect the electric generator 16 from the transmission line 18. Protection devices provide fault protection, and may include surge suppressors and circuit breakers as required. The design of transmission line interfaces is well known and need not be further described here.

In use, the vehicle 14 is parked at the site of the well 10 and the fuel gas line 28 is connected to the gas well 10. The transmission line 18 may be owned by a public utility, and the electricity thus provided may be supplied to a power grid, or used for other purposes at the well site.

The electric generator 16 may be mounted on the chassis, or within the truck box 36, or any other suitable place. The electric generator 16 is driven directly by the drive train 12 of the vehicle 14. The drive train 12 in this instance includes transmission 24 and drive shaft 26, but may include a power take off, or any other components that receive power from the vehicle engine 20. Suitable filters, not shown, are placed on the fuel gas line 28 for removing contaminants from the gas supplied by the well 10. If the gas is wet, a gas-liquid separator, not shown, may be required on the fuel gas line 28.

The power generation system thus described may require monitoring if the fuel gas is wet, in which case an operator should check the operation of the system twice per day. The volume of the gas-liquid separator will govern how often water in the liquid separator needs to be removed, and the operator will require a suitable disposal container to remove the water and dispose of it in conventional fashion.

The described system has few controls. The system is put into operation by starting the vehicle 14, and the drive train 12 engaged. The engine speed is increased to a pre-set RPM, which may be monitored using a conventional tachometer. At the pre-set speed, the cruise control of the vehicle 14 is engaged. The desired RPM is determined from the production rate of the well 10. The desired production rate of the well is obtained from the well operator. The engine 20 is held at this RPM. With suitable monitoring, the power generation system thus described may be run continuously except for service breaks.

A person skilled in the art could make immaterial modifications to the invention described in this patent document without departing from the essence of the invention.

I claim:

1. A power generation system, comprising:
a vehicle having a natural gas powered engine and drive train;
a fuel gas line for feeding the natural gas powered engine from a gas well;
an electric power generator driven by the drive train of the vehicle, the electric power generator having an electrical output; and
a transmission line interface for receiving electrical output from the electric power generator and delivering electrical energy to a transmission line.

2. The power generation system of claim 1 in which the vehicle is parked at a well site and the fuel gas line is connected to the gas well.

3. The power generation system of claim 1 in which the transmission line is owned by a public utility.
